(19) United States
(12) Patent Application Publication
(10) Pub. No.: US 2002/0011550 A1
(43) Pub. Date: Jan. 31, 2002

(54) Method for making a thermally stressed forming tool with cooling ducts and associated forming tool

(76) Inventors: Lars Christian Herzbach, Weiterstadt (DE); Franz-Rudolf Kemler, Zornheim (DE); Steffen Thiel, Woerrstadt (DE)

Correspondence Address: STRIKER, STRIKER & STENBY, 103 East Neck Road, Huntington, NY, 11743, US

(21) Appl. No.: 09/902,329

(22) Filed: Jul. 10, 2001

(30) Foreign Application Priority Data
Jul. 15, 2000 (DE) 100 34 506.9-16

(51) Int. Cl. B29C 33/02; B29C 33/38

(52) U.S. Cl. 249/79; 264/635; 264/221

(57) ABSTRACT

The forming tool for making glass or plastic products has a cooling system and is made by a method including first determining shape and position of interior spaces for cooling ducts or cooling chambers (8) of the cooling system in the forming tool, according to required location-dependent cooling performance in the cooling system; providing a vacuum-tight sealed capsule (4) containing at least two materials (6,7) in which the interior spaces having the appropriate shape and position are formed by providing predetermined bounding surfaces (5) between the at least two materials, wherein one of the materials is a heat-resistant filling material (6) that is soluble in a liquid; subjecting the vacuum-tight sealed capsule to a hot-isostatic-pressing process to form a combined body within the capsule (4), in which the filling material (6) is incorporated; then working the combined body to form a required predetermined outer surface of the forming tool and removing the filling material (6) from the combined body to provide a finished forming tool with the cooling system.

### BACKGROUND OF THE INVENTION

1. Field of the Invention

The present invention relates to a method of making a forming tool that is thermally stressed in operation with cooling ducts or channels. It also relates to a forming tool that is thermally stressed in operation, which is provided with cooling ducts or channels.

2. Related Art

Forming tools, which are usually strongly thermally stressed during forming of hot glass or plastic, are used to make glass or plastic products with predetermined shapes in glass and plastic manufacturing processes. In order to keep this thermal stress within certain limits and to cool the forming tool more quickly, so that cycle time is reduced, i.e. to provide a higher production rate, the forming tools are provided with channels or ducts for cooling. Cooling water or cooling air flows through these cooling channels or ducts in the forming tool so that the temperature of the forming tool is reduced. The forming tools may also be made with a sufficiently conductive material, such as coppers which dissipates heat faster.

Currently cooling ducts are provided by passages for air or water in the forming tool structure, especially by deeply bored passages. The cooling ducts are machined in half-pieces to form three-dimensional cooling ducts. These half-pieces are subsequently bonded or attached to each other, e.g., by welding or soldering. In the first place, this manufacturing method is considerably expensive, since the processing requires considerable effort and is time consuming. Secondly, the machines and tools required for the machining are expensive.

As shown in FIG. 3, because of their two-dimensional structure or shape known bored cooling ducts have the disadvantage that the cooling efficiencies cannot be optimized. The wall thickness of the forming tool is comparatively thick at the transition 1a in the forming tool 1 between the passages 2,3 with different diameters, so that the cooling efficiency is reduced at this point.

### SUMMARY OF THE INVENTION

It is an object of the present invention to provide a method of making a forming tool provided with cooling ducts, which is thermally stressed in operation, which facilitates a significant reduction in manufacturing effort for forming tools with complex cooling systems and which eliminates previous machining of half-pieces.

It is another object of the present invention to provide a method of making a forming tool provided with cooling ducts, which is thermally stressed in operation, which allows a location-dependent optimization of the cooling performance in contrast to bored cooling ducts and which widens the application range of the resulting complex cooling system.

It is a further object of the present invention to provide a thermally stressed forming tool for forming hot glass or plastic of the above-described type that has improved cooling ducts for efficient cooling during operation.

According to the invention the method for making a forming tool for shaping hot glass or plastic, which is thermally stressed during operation, with a cooling system comprising cooling ducts, includes the steps of:

a) determining shape and position of interior spaces in a forming tool, the interior spaces consisting of the cooling ducts or cooling chambers of the cooling system for the forming tool, according to required location-dependent cooling performance of the cooling system;

b) providing a vacuum-tight sealed capsule containing at least two materials in which the interior spaces having the appropriate shape and position are formed by providing bounding surfaces between the at least two materials, wherein one of the at least two materials is a heat-resistant filling material that is soluble in a liquid;

c) subjecting the vacuum-tight sealed capsule to a hot-isostatic-pressing process to form a combined body within the capsule, said filling material being incorporated in the combined body;

d) working the combined body to form the required predetermined outer surface of the forming tool; and

e) removing the filling material from the combined body to provide the finished forming tool with the appropriately designed interior spaces forming the cooling system.

The method according to the invention has the advantage that a forming tool can be made having a cooling system with an arbitrarily complex cooling duct structure. The cooling duct structure can take a wide variety of different shapes and forms. A prior manufacture of the forming tool in two half-pieces with the cooling system structure in both halves, which are later joined together, is not necessary. Because of that change the machining or processing effort can be significantly reduced. The cooling performance can be optimized in a location-dependent manner by a suitable design for the location and shape of the bounding surfaces between the filling material and the material surrounding it.

The hot-isostatic-pressing process, abbreviated “HIP process”, is previously well known in the manufacturing arts and does not require detailed description here. The two materials combined with each other can be the following general types: powder/powder, solid/powder and solid/solid.

According to a preferred embodiment of the invention the filling material is a heat-resistant or temperature-resistant soluble salt. This material is comparatively inexpensive and permits simple removal of the filling material to free the interior spaces forming the cooling chambers and/or ducts. This advantage is especially significant when the salt is water-soluble, so that no expensive environmentally unfriendly solvent must be used. Preferably potassium sulfate, K₂SO₄, can be used as the salt.

In order to stabilize the shape or form of the bounding surfaces between the materials, the salt in the capsule is compressed or compacted prior to the HIP process.

According to further very advantageous preferred embodiments of the method the second material is provided by a metallic or ceramic body or a suitable powder. In these embodiments the material system for the forming tool can be optimized in regard to mechanical and also thermal properties.

The invention also includes the forming tool that is thermally stressed during operation and provided with at least one cooling duct according to the method of the invention in which the cooling duct is formed by a hollow interior space provided in a combined body produced by a not-isostatic-pressing process.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a diagrammatic cross-sectional view of the structure of the later-to-be-formed forming tool in a vacuum-tight sealed capsule with two material systems enclosed in it, of which one is a filling material releasable from the capsule, which fills the later-to-be-formed cooling ducts in an HIP process,

FIG. 2 is a diagrammatic cross-sectional view of a combined body for forming the forming tool according to the invention after the HIP process; and

FIG. 3 is a diagrammatic cross-sectional view through a forming tool with cooling ducts or passages according to the prior art.

### DESCRIPTION OF THE PREFERRED EMBODIMENTS

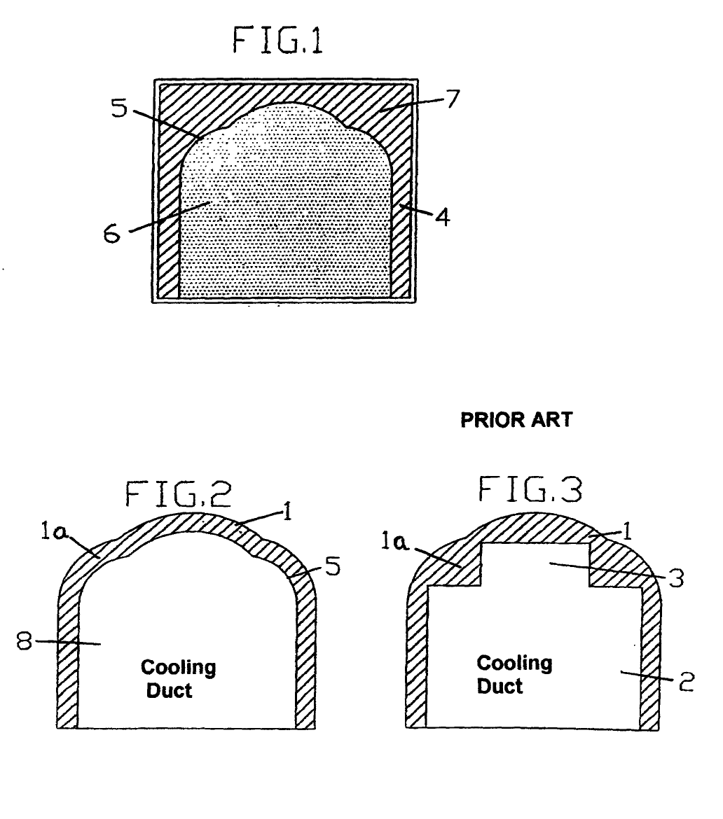

In the method according to the invention for making cooling ducts in thermally stressed forming tools, as shown in FIGS. 1 and 2, first the shape and position of the cooling system, i.e. the cooling duct, within the forming tool, are established or determined immediately after calculation of the required cooling performance.

According to FIG. 1 the outer casing or jacket (“outer skin”) of the to-be-formed forming tool is provided by a capsule 4. The line 5 in FIG. 1 shows the position and shape of the calculated cooling system, i.e. the shape and position of inner surface of a cooling duct to be formed within the capsule 4. This contour or surface 5 is provided in the capsule 4 by a suitably shaped body 6 of salt powder or an equivalent medium, which is heat- or temperature-resistant and soluble in liquids. For example, potassium sulfate (K₂SO₄) is a suitable salt.

The salt powder can be compressed or compacted, e.g., by a press, when necessary.

The suitably shaped salt body 6 is enclosed either by a solid and/or powdery material 7. When a solid material, i.e. a suitable solid body, forms the interface to the salt powder 6, the salt does not need to be made to form a shape-maintaining stable body, because the solid material 7 can then provide the predetermined shape of the cooling duct by suitable shaping of it.

The combination of the salt body 6 and the material 7 is then sealed vacuum-tightly in the capsule 4 and subjected to a HIP process (hot-isostatic pressing process). The embedded materials 6,7 are then sintered to bond them together to form a compact article.

The individual material ingredients are diffused into each other and are bonded together by the HIP process.

In order to obtain the predetermined dimensions in the finished article, appropriate measurements must be maintained during the establishment of the shape or contour.

After the HIP process the capsule 4 is worked or processed and the remaining combined body is machined or mechanically worked into the predetermined required shape for the forming tool.

The forming tool so made is bored through its base and salt 6 is released through the passage or hole that is formed. After that salt is washed out with a suitable solvent. The desired cooling chamber or duct 8 bounded by the interior surface 5, is thus provided in the forming tool by the method of the invention.

A prior art forming tool 1, similar to that of FIG. 2, made with a die or press tool, is shown in FIG. 3. As shown by comparison with the prior art forming tool 1 shown in FIG. 3 with the transitional region 1a, the method according to the invention permits the optimization of cooling performance or efficiency in a simple manner by providing flexibility in the shape and position of the interior surface or shape of the cooling ducts. Furthermore the method according to the invention permits manufacture of cooling systems in forming tools with complex geometry, which is a substantial improvement. Indeed these systems can be manufactured in a comparatively simple manner with a salt body 6 having a suitably contoured surface 5.

It is understandable that the forming tool with the cooling duct 8 can be used for both water-cooling and air-cooling.

The disclosure in German Patent Application 100 34 506.9-16 of Jul. 15, 2000 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a method of making a forming tool that is thermally stressed in operation with cooling ducts and forming tool made by this method, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A method for making a forming tool with a cooling system, which is thermally stressed during operation, comprising the steps of:
a) determining shape and position of interior spaces in a forming tool, the interior spaces consisting of cooling ducts or cooling chambers (8) of the cooling system for the forming tool, according to required location-dependent cooling performance of the cooling system;
b) providing a vacuum-tight sealed capsule (4) containing at least two materials (6,7) and providing predetermined bounding surfaces (5) between the at least two materials for formation of the interior spaces in the at least two materials, wherein one of the at least two materials is a heat-resistant filling material (6) that is soluble in a liquid;
c) subjecting the vacuum-tight sealed capsule (4) to a hot-isostatic-pressing process to form a combined body within the capsule (4), in which said filling material (6) is incorporated;
d) working the combined body to form a required predetermined outer surface of the forming tool; and
e) removing the filling material (6) from the combined body to provide said finished forming tool with said interior spaces forming the cooling system.

2. The method as defined in claim 1, wherein said filling material (6) is a heat-resistant salt that is soluble in a solvent.

3. The method as defined in claim 2, wherein said solvent is water.

4. The method as defined in claim 2, wherein said salt is potassium sulfate.

5. The method as defined in claim 2, further comprising pre-compressing or compacting said salt in said capsule (4) prior to said subjecting to said hot-isostatic pressing process.

6. The method as defined in claim 1, wherein a second of said at least two materials comprises a metallic solid, a ceramic sold or a powder.

7. A forming tool provided with at least one cooling duct, said forming tool being formed by a method comprising making a combined body from a hot-isostatic-pressing process and providing a hollow interior space forming said at least one cooling duct in the combined body.

8. A forming tool with a cooling system made by a method comprising the steps of:
a) determining shape and position of interior spaces in a forming tool, the interior spaces consisting of cooling ducts or cooling chambers (8) of the cooling system for the forming tool, according to required location-dependent cooling performance of the cooling system;
b) providing a vacuum-tight sealed capsule (4) containing at least two materials (6,7) and providing predetermined bounding surfaces (5) between the at least two materials to form the interior spaces in the at least two materials, wherein one of the at least two materials is a heat-resistant filling material (6) that is soluble in a liquid;
c) subjecting the vacuum-tight sealed capsule to a hot-isostatic-pressing process to form a combined body within the capsule (4), in which said filling material (6) is incorporated;
d) working the combined body to form a required predetermined outer surface of the forming tool; and
e) removing the filling material (6) from the combined body to provide said finished forming tool with said interior spaces forming the cooling system.
